(19) United States
(12) Patent Application Publication
(10) Pub. No.: US 2026/0154633 A1
(43) Pub. Date: Jun. 4, 2026

(54) COMPUTER-IMPLEMENTED SYSTEM AND METHOD FOR AUTOMATICALLY MANAGING DYNAMIC WORKFORCES IN ORGANIZATIONS

(71) Applicants: Mohit Shah, Cumming, GA (US); Sunil Varyani, The Hills, TX (US)

(72) Inventors: Mohit Shah, Cumming, GA (US); Sunil Varyani, The Hills, TX (US)

(21) Appl. No.: 19/286,075

(22) Filed: Jul. 30, 2025

Related U.S. Application Data
(60) Provisional application No. 63/727,701, filed on Dec. 4, 2024.

(51) Int. Cl. G06Q 10/0631; G06Q 10/067

(52) U.S. Cl. CPC G06Q 10/06312; G06Q 10/0672

(57) ABSTRACT

A computer-implemented system and method for automatically managing dynamic workforces in organizations, are disclosed. The process begins obtaining workforce operational data associated with workforces, from data sourcing systems. The process followed by obtaining inputs associated with the organizations from communication devices associated with the users. The process includes determining the workforces present in the organizations by analyzing employee lists. The process includes determining a number of projected workforces by applying the planning inferences for future weeks. The process further includes determining a capacity of staffing for workloads based on the comparison of the obtained requirements of workforce allocation with the determined number of projected workforces. The process further includes generating responses based on the determined capacity of staffing. The process further includes providing the responses, as an output, to the users on user interfaces associated with the communication devices associated with the users.

### CROSS REFERENCE TO RELATED APPLICATION(S)

This application claims the priority to incorporates by reference the entire disclosure of U.S. provisional patent application No. 63/727,701, filed on Dec. 4, 2024, titled “COMPUTER-IMPLEMENTED SYSTEM AND METHOD FOR DYNAMIC WORKFORCE PLANNING”.

### TECHNICAL FIELD

Embodiments of the present disclosure relate to workforce management and capacity planning systems, and more particularly relate to a computer-implemented system and method for automatically managing dynamic workforces in one or more organizations.

### BACKGROUND

Workforce management and capacity planning are critical aspects of running efficient and cost-effective operations in many industries, particularly in one or more contact centers and one or more customer service organizations. As businesses strive to optimize resources and meet fluctuating customer demands, the need for sophisticated planning tools has grown significantly.

Traditional methods of capacity planning rely on manual processes, spreadsheets, and disparate systems, which may be time-consuming, error-prone, and lack an ability to quickly adapt to changing business conditions. The traditional methods may struggle to accurately forecast staffing needs, leading to at least one of: overstaffing that increases cost and understaffing that compromises service quality.

The complexity of modern business environments, with multiple channels of customer interaction, varying skill requirements, and intricate scheduling constraints, further compounds the challenges of effective capacity planning. One or more organizations must consider factors such as seasonal fluctuations, special events, employee attrition, training periods, and regulatory requirements when determining the staffing needs.

Additionally, the increasing focus on employee engagement and work-life balance necessitates more flexible and responsive workforce management strategies. The workforce management strategies include accommodating part-time and remote work arrangements, managing diverse shift patterns, and ensuring fair distribution of workloads.

Therefore, there is a need for an improved computer-implemented system and method for automatically managing dynamic workforces in one or more organizations, by providing accurate one or more forecasts, streamlining planning processes, and providing actionable insights for decision-making to improve operational efficiency and maintain high levels of customer satisfaction, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented method for automatically managing dynamic workforces in one or more organizations, is disclosed. The computer-implemented method comprises obtaining, by one or more hardware processors, workforce operational data associated with one or more workforces, from one or more data sourcing systems. The computer-implemented method further comprises obtaining, by the one or more hardware processors, one or more inputs associated with the one or more organizations from one or more communication devices associated with the one or more users. In an embodiment, the one or more inputs comprise at least one of: one or more requirements of allocation of workforces for future business needs, one or more requirements of the future business needs, and one or more planning inferences comprising at least one of: one or more projected attrition inferences, one or more projected shrinkage inferences, and one or more projected hiring inferences, on the one or more workforces.

The computer-implemented method further comprises determining, by the one or more hardware processors, the one or more workforces present in the one or more organizations by analyzing one or more employee lists. The computer-implemented method further comprises determining, by the one or more hardware processors, a number of projected workforces by applying the one or more planning inferences for one or more future weeks. The computer-implemented method further comprises comparing, by the one or more hardware processors, the obtained one or more requirements of workforce allocation with the determined number of projected workforces.

The computer-implemented method further comprises determining, by the one or more hardware processors, a capacity of staffing for one or more workloads based on the comparison of the obtained one or more requirements of workforce allocation with the determined number of projected workforces. The computer-implemented method further comprises generating, by the one or more hardware processors, one or more responses based on the determined capacity of staffing. The one or more responses comprise at least one of: requirement of recruitment of the one or more workforces in future and managing staffing gaps by utilizing the one or more workforces present in the one or more organizations to work overtime. The computer-implemented method further comprises providing, by the one or more hardware processors, the one or more responses, as an output, to the one or more users on one or more user interfaces associated with the one or more communication devices associated with the one or more users.

In an embodiment, generating the one or more responses comprises: (a) obtaining, by the one or more hardware processors, the one or more inputs from the one or more communication devices associated with the one or more users, wherein the one or more inputs comprise one or more queries associated with one or more scenarios, and wherein the one or more scenarios comprise at least one of: recruitment of one or more workforces based on changes in demand of the one or more workforces in a time duration, and the recruitment of the one or more workforces based on the changes in the recruitment at a specific location; and (b) generating, by the one or more hardware processors, the one or more responses based on the one or more queries using at least one of: historical data, one or more trends, and one or more business model inferences.

In another embodiment, the historical data comprise at least one of: one or more recruitment records, historical workforce data, and performance and productivity data. The one or more trends comprise at least one of: relationship between the demand and the recruitment, seasonal recruitment patterns, availability of one or more regional workforces, recruitment lead time, attrition and retention rates, and cost trends. The one or more business model inferences comprise at least one of: recruitment-to-demand elasticity, location-based hiring constraints, operational capacity limits, recruitment cost and time inferences, workforce productivity metrics, attention and retention forecasting, and revenue per workforce.

In yet another embodiment, computer-implemented method further comprising: (a) obtaining, by the one or more hardware processors, information associated with the recruitment of each workforce of the one or more workforces; (b) analyzing, by the one or more hardware processors, one or more factors comprising at least one of: wages, overtime pay, potential recruitment expenses, training expenses, associated with each workforce of the one or more workforces; (c) generating, by the one or more hardware processors, the one or more responses associated with one or more expense information for each workforce of the one or more workforces; and (d) generating, by the one or more hardware processors, one or more recommendations on a budgetary impact of at least one of: maintaining the one or more workforces, increasing the one or more workforces, and decreasing the one or more workforces, by analyzing the one or more expense information associated with each workforce of the one or more workforces.

In yet another embodiment, computer-implemented method further comprising: (a) analyzing, by the one or more hardware processors, one or more workforce based factors comprising at least one of: the one or more workloads, one or more business goals, one or more seasonal trends, and one or more operational trends; and (b) generating, by the one or more hardware processors, the one or more responses associated with allocation of the one or more workforces to be required to meet the demand in each scenario of the one or more scenarios.

In yet another embodiment, the computer-implemented method further comprising generating, by the one or more hardware processors, one or more reports based on at least one of: the one or more requirements of the allocation of workforces for the future business needs, the one or more responses, the one or more scenarios. The one or more reports comprise at least one of: determined workforces for each scenario, financial cost projections, one or more graphs showing how needs change over time, and one or more recommendations for recruitment adjustments.

In yet another embodiment, the computer-implemented method further comprising generating, by the one or more hardware processors, the one or more projected attrition inferences using a machine learning (ML) model, by: (a) collecting, by the one or more hardware processors, one or more training datasets comprising one or more first historical workforce datasets, wherein the one or more first historical workforce datasets comprise at least one of: one or more past attrition records, one or more employee attributes, and work location and team dynamics; (b) generating, by the one or more hardware processors, one or more first features comprising at least one of: tenure duration, attrition seasonality, risk scores, and attrition trends by department, based on the one or more training datasets; (c) training, by the one or more hardware processors, the ML model to learn one or more patterns of past attritions comprising at least one of: who is leaving from the one or more organizations and under what conditions, how organizational and external events impact turnover, and trends in voluntary versus involuntary exits; and (d) generating, by the one or more hardware processors, the one or more projected attrition inferences using the trained ML model.

In yet another embodiment, the computer-implemented method further comprising generating, by the one or more hardware processors, the one or more projected shrinkage inferences using the machine learning (ML) model, by: (a) collecting, by the one or more hardware processors, the one or more training datasets comprising one or more second historical workforce datasets, wherein the one or more second historical workforce datasets comprise at least one of: one or more employee attrition records, past recruitment cycles and hiring rates, one or more resignation trends by role, department, and location, one or more cyclical shrinkage patterns, and internal mobility; (b) generating, by the one or more hardware processors, one or more second features comprising at least one of: time-based variables, employee attributes, location-based factors, demand fluctuations, and performance metrics, based on the one or more training datasets; (c) training, by the one or more hardware processors, the ML model to learn at least one of: one or more patterns of past workforce shrinkage, correlations between events and staff reductions, and recurring trends over specific periods and business cycles; and (d) generating, by the one or more hardware processors, the one or more projected shrinkage inferences based on the trained ML model.

In yet another embodiment, the one or more data sourcing systems comprise at least one of: one or more human resource information systems (HRIS), one or more scheduling tools, and one or more financial reporting systems. The workforce operational data comprise at least one of: an employee roster, work hours, one or more historical performance metrics, one or more business targets, and metadata associated with the one or more workforces.

In an aspect, a computer-implemented system for automatically managing dynamic workforces in one or more organizations, is disclosed. The computer-implemented system comprises one or more hardware processors and a memory. The memory unit is coupled to the one or more hardware processors. The memory unit comprises a plurality of subsystems in form of programmable instructions executable by the one or more hardware processors.

The plurality of subsystems comprises a data obtaining subsystem configured to: (a) obtain workforce operational data associated with one or more workforces, from one or more data sourcing systems; and (b) obtain one or more inputs associated with the one or more organizations from one or more communication devices associated with the one or more users. The one or more inputs comprise at least one of: one or more requirements of allocation of workforces for future business needs, one or more requirements of the future business needs, and one or more planning inferences comprising at least one of: one or more projected attrition inferences, one or more projected shrinkage inferences, and one or more projected hiring inferences, on the one or more workforces.

The plurality of subsystems further comprises a workforce determining subsystem configured to: (a) determine the one or more workforces present in the one or more organizations by analyzing one or more employee lists; and (b) determine a number of projected workforces by applying the one or more planning inferences for one or more future weeks.

The plurality of subsystems further comprises a staffing capacity determining subsystem configured to: (a) compare the obtained one or more requirements of workforce allocation with the determined number of projected workforces; and (b) determine a capacity of staffing for one or more workloads based on the comparison of the obtained one or more requirements of workforce allocation with the determined number of projected workforces.

The plurality of subsystems further comprises a response generating subsystem configured to generate one or more responses based on the determined capacity of staffing. The one or more responses comprise at least one of: requirement of recruitment of the one or more workforces in future and managing staffing gaps by utilizing the one or more workforces present in the one or more organizations to work overtime.

The plurality of subsystems further comprises an output subsystem configured to provide the one or more responses, as an output, to the one or more users on one or more user interfaces associated with the one or more communication devices associated with the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting a computer-implemented system for automatically managing dynamic workforces in one or more organizations, in accordance with an embodiment of the present invention;

FIG. 2 illustrates a detailed view of the computer-implemented system for automatically managing the dynamic workforces in the one or more organizations, such as those shown in FIG. 1, in accordance with an embodiment of the present disclosure;

FIG. 3A illustrates an exemplary first visual representation of one or more user interfaces associated with one or more communication devices depicting one or more workforce metrics, in accordance with an embodiment of the present disclosure;

FIG. 3B illustrates an exemplary second visual representation of the one or more user interfaces depicting one or more workforce plans, in accordance with an embodiment of the present disclosure;

FIG. 3C illustrates an exemplary third visual representation of the one or more user interfaces depicting an addition of new employee acquisition, in accordance with an embodiment of the present disclosure;

FIG. 3D illustrates an exemplary fourth visual representation of the one or more user interfaces depicting an employee roster, in accordance with an embodiment of the present disclosure;

FIG. 3E illustrates an exemplary fifth visual representation of the one or more user interfaces depicting an operational dashboard, in accordance with an embodiment of the present disclosure;

FIG. 3E illustrates an exemplary fifth visual representation of the one or more user interfaces depicting an operational dashboard, in accordance with an embodiment of the present disclosure;

FIG. 3F illustrates an exemplary sixth visual representation of the one or more user interfaces depicting a hierarchy structure of the one or more organizations for each capacity plan, in accordance with an embodiment of the present disclosure;

FIG. 3G illustrates an exemplary seventh visual representation of the one or more user interfaces depicting staffing capacity plans (over/under workforces), in accordance with an embodiment of the present disclosure;

FIG. 4 illustrates an exemplary system architecture for dynamic workforce planning, in accordance with an embodiment of the present disclosure; and

FIG. 5 illustrates a flow chart illustrating a computer-implemented method for automatically managing the dynamic workforces in the one or more organizations, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

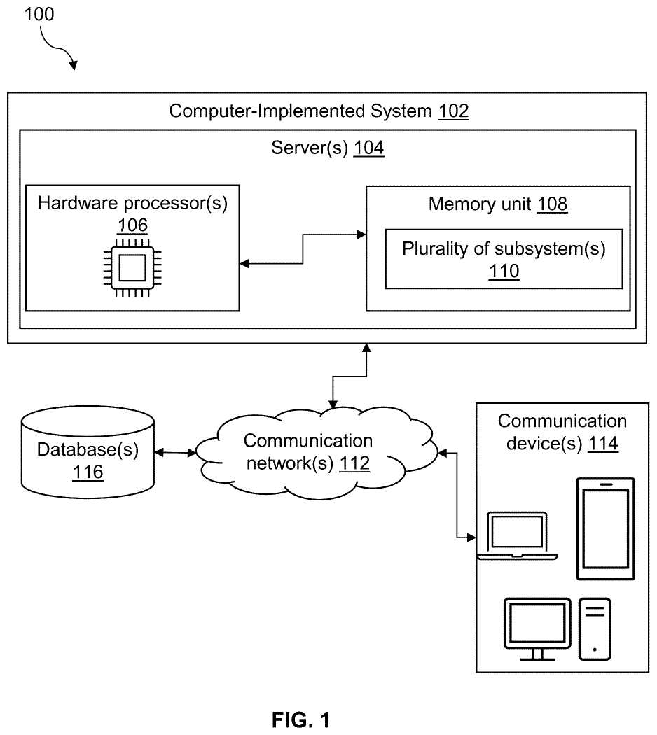

Referring now to the drawings, and more particularly to FIG. 1 through FIG. 5, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 depicting a computer-implemented system 102 for automatically managing dynamic workforces in one or more organizations, in accordance with an embodiment of the present invention.

According to an exemplary embodiment of the present disclosure, the network architecture 100 may include the computer-implemented system 102, one or more databases 116, and one or more communication devices 114. The computer-implemented system 102, the one or more databases 116, and the one or more communication devices 114 may be communicatively coupled via one or more communication networks 112, ensuring seamless data transmission, processing, and decision-making. The computer-implemented system 102 acts as a central processing unit within the network architecture 100, responsible for dynamic workforce planning. The computer-implemented system 102 is configured to execute a set of computer-readable instructions that control a plurality of subsystems 110.

In an exemplary embodiment, the computer-implemented system 102 comprises one or more servers 104. The one or more servers 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106.

The one or more servers 104 comprises the one or more hardware processors 106 and a memory unit 108. The memory unit 108 is operatively connected to the one or more hardware processors 106. The memory unit 108 comprises a set of computer-readable instructions in the form of the plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the computer-implemented system 102 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like that enhance ability of the computer-implemented system 102 to process real-time data from one or more sources simultaneously.

In an exemplary embodiment, the one or more databases 116 may be configured to store and manage data related to various aspects of the computer-implemented system 102. The one or more databases 116 may store at least one of, but not limited to, workforce operational data, employee data, one or more reports, and the like. The one or more databases 116 serve as a centralized repository for critical data elements that are integral to the secure operation of the computer-implemented system 102, enabling efficient management and synchronization of workforce-related information, including the employee data, scheduling, one or more workforce metrics, expenses, and scenario planning. The one or more databases 116 enable the computer-implemented system 102 to dynamically retrieve, analyze, and update the stored data in real-time, for providing dynamic workforce planning. The one or more databases 116 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, object storage systems (e.g., Amazon S3, PostgresDB), and the like.

In an exemplary embodiment, the one or more communication devices 114 are configured to enable one or more users to interact with the computer-implemented system 102. The one or more communication devices 114 may be digital devices, computing devices, and/or networks. The one or more communication devices 114 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more communication devices 114 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 112 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an aspect of the present disclosure, the computer-implemented system 102 is configured to automatically manage dynamic workforces and plans in the one or more organizations. The computer-implemented system 102 is initially configured to obtain workforce operational data associated with one or more workforces, from one or more data sourcing systems. The computer-implemented system 102 is further configured to obtain one or more inputs associated with the one or more organizations from the one or more communication devices 114 associated with the one or more users. In an embodiment, the one or more inputs may include at least one of: one or more requirements of allocation of workforces for future business needs, one or more requirements of the future business needs, and one or more planning inferences comprising at least one of: one or more projected attrition inferences, one or more projected shrinkage inferences, and one or more projected hiring inferences, on the one or more workforces.

The computer-implemented system 102 is further configured to determine the one or more workforces present in the one or more organizations by analyzing one or more employee lists. The computer-implemented system 102 is further configured to determine a number of projected workforces by applying the one or more planning inferences for one or more future weeks. The computer-implemented system 102 is further configured to compare the obtained one or more requirements of workforce allocation with the determined number of projected workforces. The computer-implemented system 102 is further configured to determine a capacity of staffing for one or more workloads based on the comparison of the obtained one or more requirements of workforce allocation with the determined number of projected workforces.

The computer-implemented system 102 is further configured to generate one or more responses based on the determined capacity of staffing. In an embodiment, the one or more responses may include at least one of: requirement of recruitment of the one or more workforces in future and managing staffing gaps by utilizing the one or more current workforces to work overtime. The computer-implemented system 102 is further configured to provide the one or more responses, as an output, to the one or more users on one or more user interfaces associated with the one or more communication devices 114 associated with the one or more users.

In an exemplary embodiment, the computer-implemented system 102 may be implemented by way of a single device or a combination of multiple devices that may be operatively connected or networked together. The computer-implemented system 102 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 116, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the computer-implemented system 102, and the one or more communication devices 114 connected to the one or more databases 116, one skilled in the art can envision that the computer-implemented system 102, and the one or more communication devices 114 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the computer-implemented system 102 as is unique to the present disclosure or necessary for an understanding of the present disclosure is depicted and described. The remainder of the construction and operation of the computer-implemented system 102 may conform to any of the various current implementations and practices that were known in the art.

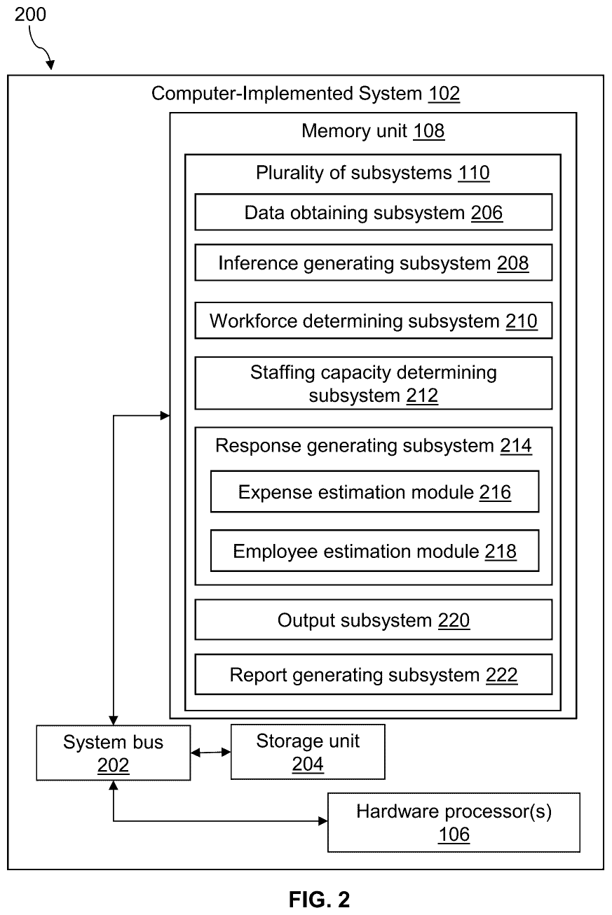

FIG. 2 illustrates a detailed view 200 of the computer-implemented system 102 for automatically managing the dynamic workforces in the one or more organizations, such as those shown in FIG. 1, in accordance with an embodiment of the present disclosure.

In an exemplary embodiment, the system 102 comprises the one or more servers 104, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108, and the storage unit 204. The system bus 202 facilitates the efficient exchange of information and instructions, enabling the coordinated operation of the computer-implemented system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106.

The plurality of subsystems 110 includes a data obtaining subsystem 206, an inference generating subsystem 208, a workforce determining subsystem 210, a staffing capacity determining subsystem 212, a response generating subsystem 214, an output subsystem 220, and a report generating subsystem 222. The response generating subsystem 214 includes an expense estimation module 216 and an employee estimation module 218.

The one or more hardware processors 106 associated within the one or more servers 104, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 116 such as those shown in FIG. 1. The storage unit 204 may store, but not limited to, recommended course of action sequences dynamically generated by the computer-implemented system 102. The action sequences comprise data-obtaining, inference generating, present/current workforce determining, projected workforce determining, output forecasting, report generating, and the like. Additionally, the storage unit 204 may retain previous action sequences for comparison and future reference, enabling continuous refinement of the computer-implemented system 102 over time. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 110 includes the data obtaining subsystem 206 that is communicatively connected to the one or more hardware processors 106. The data obtaining subsystem 206 is configured to connect to one or more data sourcing systems including at least one of: one or more Human Resources Information Systems (HRIS), one or more scheduling tools, one or more financial reporting systems, and the like, through the one or more communication networks 112. This connectivity enables the data obtaining subsystem 206 to obtain workforce operational data without requiring manual input from the one or more users, thus saving time and ensuring accuracy. The workforce operational data may comprise, but not restricted to, at least one of: an employee roster, work hours, one or more historical performance metrics, one or more business targets, other relevant workforce information, and the like.

In an exemplary embodiment, the data obtaining subsystem 206 is configured to allow the one or more users to set precise requirements of employee allocation tailored to upcoming business needs. The one or more users provide the requirements of upcoming business needs on the one or more user interfaces. The requirements may vary due to factors including, but not constrained to, at least one of: new one or more projects, peak season demand, shifting business priorities, and the like. This setup provides the one or more users with optimal employee allocation that aligns with actual workload demands and anticipated changes. The one or more user interfaces are associated with the one or more communication devices 114. The one or more user interfaces may include graphical displays, touchscreens, voice recognition, and other input/output mechanisms that facilitate easy access to data and control functions. Any other instructions may be provided by the one or more users to the computer-implemented system 102 via the one or more user interfaces.

The data obtaining subsystem 206 is further configured to obtain one or more inputs associated with the one or more organizations from the one or more communication devices 114 associated with the one or more users. In an embodiment, the one or more inputs may include at least one of: one or more requirements of allocation of workforces (e.g., full time equivalent (FTE) workforces) for future business needs, one or more requirements of the future business needs, and one or more planning inferences comprising at least one of: one or more projected attrition inferences, one or more projected shrinkage inferences, and one or more projected hiring inferences, on the one or more workforces.

The plurality of subsystems 110 further includes the inference generating subsystem 208 that is communicatively connected to the one or more hardware processors 106. The inference generating subsystem 208 is configured to generate the one or more projected attrition inferences using a machine learning (ML) model. For generating the one or more projected attrition inferences, the inference generating subsystem 208 is initially configured to collect one or more training datasets including one or more first historical workforce datasets. In an embodiment, the one or more first historical workforce datasets may include at least one of: one or more past attrition records (who left, when, and why), one or more employee attributes (role, tenure, age, gender, department, and performance of the one or more employees), work location and team dynamics, and one or more external factors (economic conditions and industry trends).

The inference generating subsystem 208 is further configured to generate one or more first features including at least one of: tenure duration, attrition seasonality, risk scores, and attrition trends by department, based on the one or more training datasets. The inference generating subsystem 208 is further configured to train the ML model to learn one or more patterns of past attritions comprising at least one of: who is leaving from the one or more organizations and under what conditions, how organizational and external events impact turnover, and trends in voluntary versus involuntary exits. The inference generating subsystem 208 is further configured to generate the one or more projected attrition inferences using the trained ML model. In an embodiment, the ML model may include at least one of: Logistic regression based ML model, Random Forest or XGBoost based ML model, time series based ML models, survival analysis based ML models, clustering ML model, and the like.

In an embodiment, the inference generating subsystem 208 is configured to generate the one or more projected shrinkage inferences using the machine learning (ML) model. For generating the one or more projected shrinkage inferences, the inference generating subsystem 208 is initially configured to collect the one or more training datasets including one or more second historical workforce datasets. The one or more second historical workforce datasets may include at least one of: one or more employee attrition records (voluntary and involuntary exits), past recruitment cycles and hiring rates, one or more resignation trends by role, department, and location, one or more cyclical shrinkage patterns, internal mobility (promotions and transfers), and one or more factors including market downturns and layoffs.

The inference generating subsystem 208 is further configured to generate one or more second features including at least one of: time-based variables (quarter, fiscal year, season), employee attributes (role, tenure, age, department, of the one or more employees), location-based factors (attrition by region or office), demand fluctuations (impacting hiring/firing decisions), and performance metrics, based on the one or more training datasets. The inference generating subsystem 208 is further configured to train the ML model to learn at least one of: one or more patterns of past workforce shrinkage, correlations between events and staff reductions, and recurring trends over specific periods and business cycles. The inference generating subsystem 208 is further configured to generate the one or more projected shrinkage inferences based on the trained ML model. In an embodiment, the ML model may include at least one of: Logistic regression based ML model, Random Forest or XGBoost based ML model, time series based ML models, survival analysis based ML models, clustering ML model, and the like.

The plurality of subsystems 110 further includes the workforce determining subsystem 210 that is communicatively connected to the one or more hardware processors 106. The workforce determining subsystem 210 is configured to determine the one or more workforces present in the one or more organizations by analyzing one or more employee lists. The workforce determining subsystem 210 is further configured to determine a number of projected workforces by applying the one or more planning inferences for one or more future weeks.

The plurality of subsystems 110 further includes the staffing capacity determining subsystem 212 that is communicatively connected to the one or more hardware processors 106. The staffing capacity determining subsystem 212 is configured to compare the obtained one or more requirements of workforce allocation with the determined number of projected workforces. The staffing capacity determining subsystem 212 is further configured to determine the capacity of staffing (i.e., over/under staffing) for one or more workloads based on the comparison of the obtained one or more requirements of workforce allocation with the determined number of projected workforces.

In an aspect, the one or more users may select one or more pre-built enterprise models within the computer-implement system 102. The one or more pre-built enterprise models are tailored to operational characteristics of different industries including, but not limited to, at least one of: retail, customer service, healthcare, seasonal industries such as travel and hospitality, and the like. The one or more pre-built enterprise models are configured to handle at least one of: peak traffic times, service levels, compliance requirements, and the like, specific to each industry. For one or more organizations with more specialized requirements, the computer-implement system 102 further provides the flexibility to at least one of: customize the one or more pre-built enterprise models and create entirely new one or more pre-built enterprise models, thereby enabling the computer-implement system 102 to accurately reflect the requirements of the one or more employees for each at least one of: department, project, location, and the like. This customization ensures that one or more workforce plans may adapt to at least one of: skill requirements, location-specific regulations, and client-specific service agreements.

The plurality of subsystems 110 further includes the response generating subsystem 214 that is communicatively connected to the one or more hardware processors 106. The response generating subsystem 214 is configured to generate one or more responses based on the determined capacity of staffing. The one or more responses may include at least one of: requirement of recruitment of the one or more workforces in future, managing staffing gaps by utilizing the one or more workforces present in the one or more organizations to work overtime, and the like.

In an exemplary embodiment, the response generating subsystem 214 is configured to generate the one or more responses based on one or more queries provided by the one or more users on the one or more user interfaces. The one or more queries are one or more scenarios, and the like. The one or more responses are one or more forecasts, and the like. For instance, a user of the one or more users may provide a scenario of the one or more scenarios about one of: how recruitment of the one or more employees may shift if demand were to increase by 20% in a next quarter and if the recruitment were reduced by 10% at a specific location. The response generating subsystem 214 is configured to utilize a combination of historical data, one or more identified trends, and one or more business model assumptions/inferences to generate automated one or more forecasts/responses for each scenario. In an embodiment, the historical data may include at least one of: one or more recruitment records, historical workforce data, performance and productivity data, and the like. The one or more identified trends may include at least one of: relationship between the demand and the recruitment, seasonal recruitment patterns, availability of one or more regional workforces, recruitment lead time, attrition and retention rates, cost trends, and the like. The one or more business model inferences may include at least one of: recruitment-to-demand elasticity, location-based hiring constraints, operational capacity limits, recruitment cost and time inferences, workforce productivity metrics, attention and retention forecasting, revenue per workforce, and the like.

The generation of the one or more responses accounts for one or more critical factors including, but not limited to, at least one of: seasonality which may influence peak demand and off-peak demand, major project timelines, and the like, that may temporarily affect recruitment levels. Additionally, the output forecasting considers fluctuations in workload, including busy hours and shifts, to produce accurate one or more forecasts/responses. The one or more forecasts/responses assist the one or more users in understanding potential outcomes and making data-driven decisions about the recruitment, scheduling, and reallocating the one or more employees, thereby ensuring that the one or more users are prepared for both expected business changes and unexpected business changes.

In an exemplary embodiment, the response generating subsystem 214 is configured with an expense estimation module 216. The expense estimation module 216 is configured to estimate financial implications of each workforce plan of the one or more workforce plans. For expense estimation, the expense estimation module 216 in the response generating subsystem 214 is initially configured to obtain information associated with the recruitment of each workforce of the one or more workforces. The expense estimation module 216 is further configured to analyze one or more expense factors including, but not restricted to, at least one of: wages, overtime pay, potential recruitment expenses, training expenses, and the like. Based on the expense factors, the response generating subsystem 214 is configured to generate the one or more forecasts/responses associated with one or more expense information for each workforce of the one or more workforces tailored to each scenario. This allows the one or more users to compare the expenses associated with the one or more workforce plans, providing one or more recommendations on a budgetary impact of one of: maintaining headcount (workforces), increasing headcount, and decreasing headcount, by analyzing the one or more expense information associated with each workforce of the one or more workforces.

The response generating subsystem 214 is further configured with the employee estimation module 218. The employee estimation module 218 is configured to estimate workforce implications of each workforce plan. The employee estimation module 218 is configured to estimate the one or more employees required to meet projected demand in each scenario. The employee estimation module 218 is configured to analyze at least one of: the one or more workloads, one or more business goals, one or more seasonal trends, one or more operational trends, and the like, to determine optimal recruitment levels, ensuring that the one or more workforce plans avoid over-recruitment, which may lead to unnecessary expenses and under recruitment which may compromise service levels. Based on the estimation of the employee estimation module 218, the response generating subsystem 214 is configured to generate the one or more forecasts associated with allocation of the one or more employees to be required to meet the demand in each scenario of the one or more scenarios.

The plurality of subsystems 110 further includes the output subsystem 220 that is communicatively connected to the one or more hardware processors 106. The output subsystem 220 is configured to provide the one or more responses, as the output, to the one or more users on the one or more user interfaces associated with the one or more communication devices 114 associated with the one or more users.

The plurality of subsystems 110 further includes the report generating subsystem 222 that is communicatively connected to the one or more hardware processors 106. The report generating subsystem 222 is configured to employ the requirements of the upcoming business needs provided by the one or more users, the one or more forecasts, scenario analysis, and the like, for automatically generating one or more reports. The one or more reports include a variety of key information such as, but not constrained to, at least one of: projected headcounts/workforces for each scenario, financial cost projections, one or more graphs showing how needs change over time, recommendations for recruitment adjustments, and the like.

The projected headcounts for each scenario allow the one or more users to see how recruitment needs may evolve in different business contexts. The financial cost projections may include, but not limited to, at least one of: cost breakdowns for the wages, overtime, and other recruitment-related expenses, thereby assisting the one or more users in visualizing the economic impact of each recruitment decision. The one or more graphs illustrate how recruitment requirements and expenses change over time, making it easier for the one or more users to track fluctuations and anticipate future requirements. The recommendations for the recruitment adjustments indicate areas where at least one of: recruiting, redistributing the one or more employees, adjusting work hours, and the like may be necessary to optimize efficiency. The one or more users may access the one or more reports via an operational dashboard on a user interface, where the one or more users may easily filter and view data, ensuring that the information is tailored to the specific needs and accessible in real-time.

The one or more reports provide detailed insights into the recruitment requirements and the associated expenses for the selected one or more scenarios. The one or more reports are configured to guide decision-making, assisting the one or more users in determining one of: the one or more users need to recruit the one or more employees, adjust working hours, redistribute the one or more employees across different teams and projects, and the like.

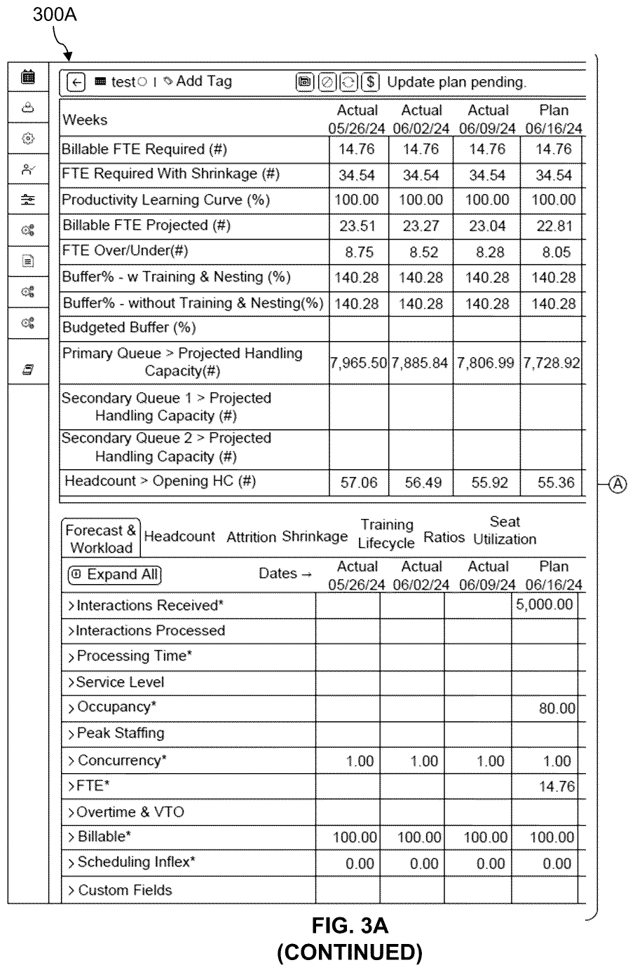

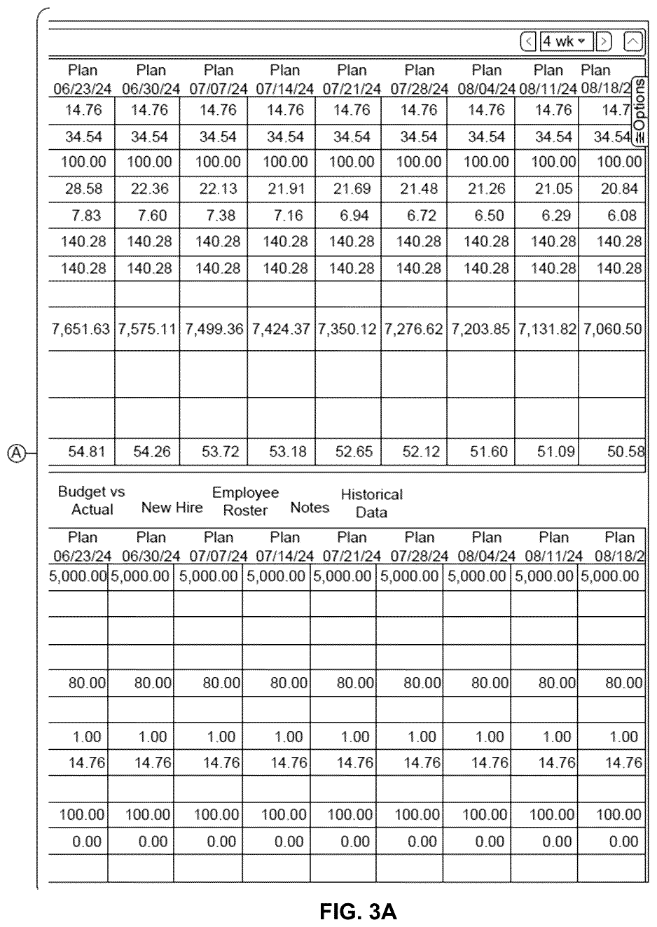

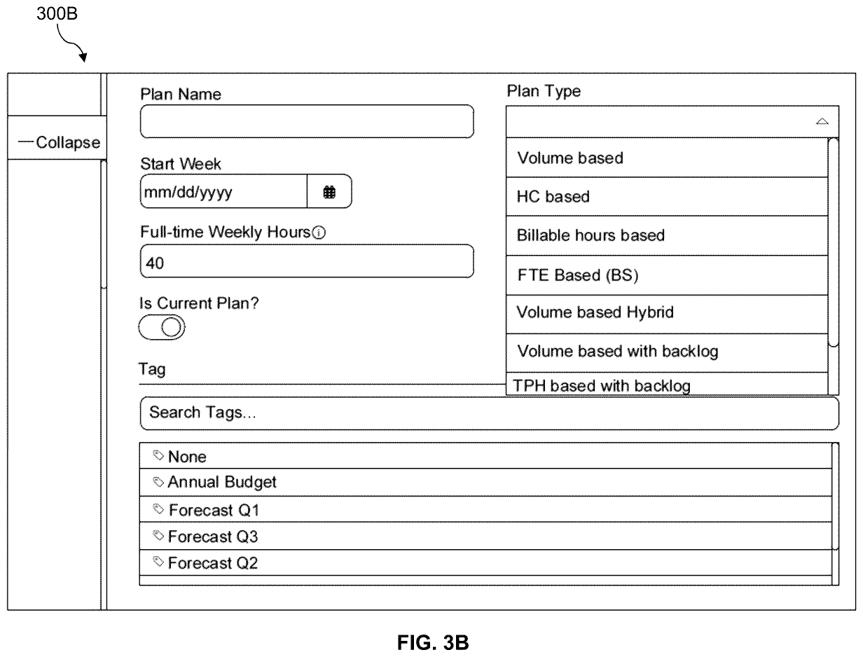

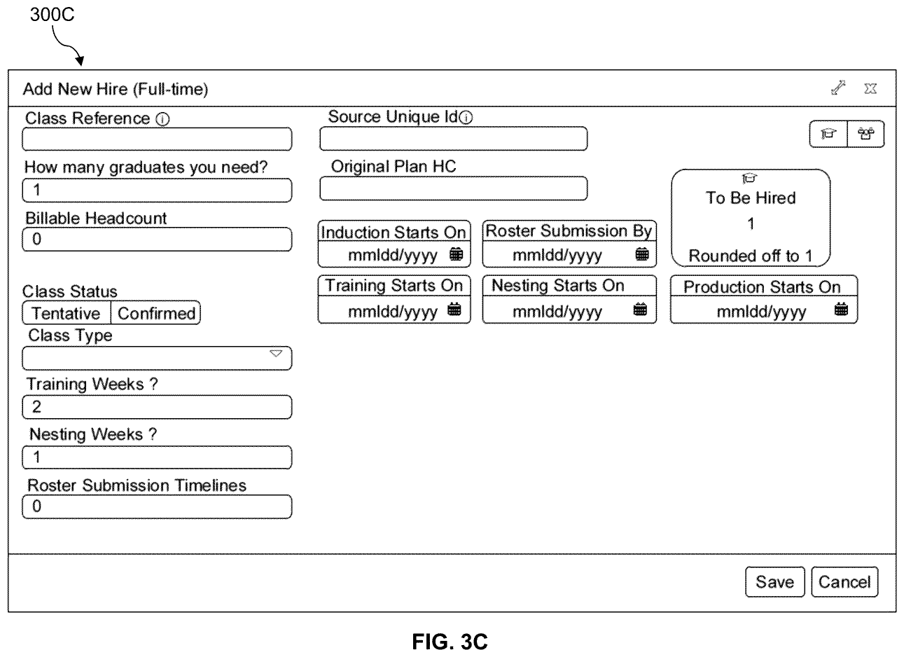

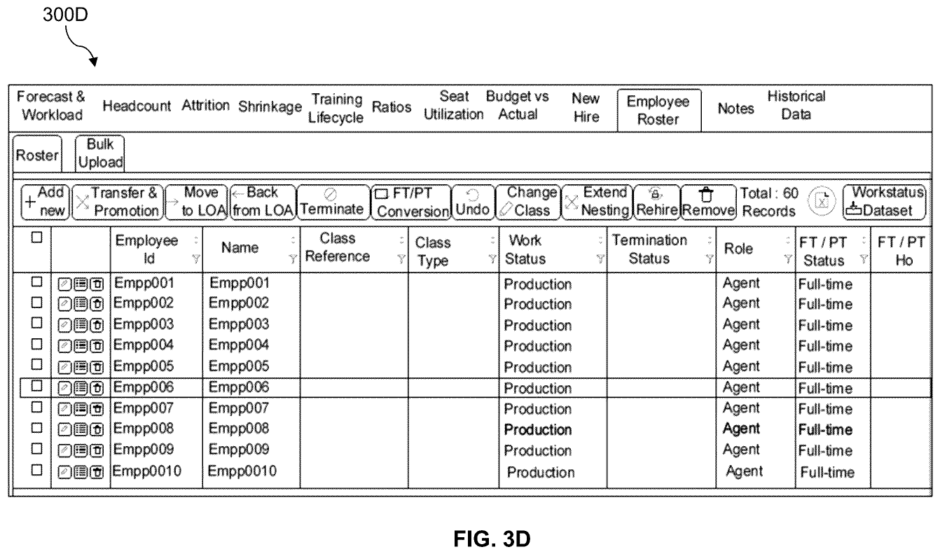

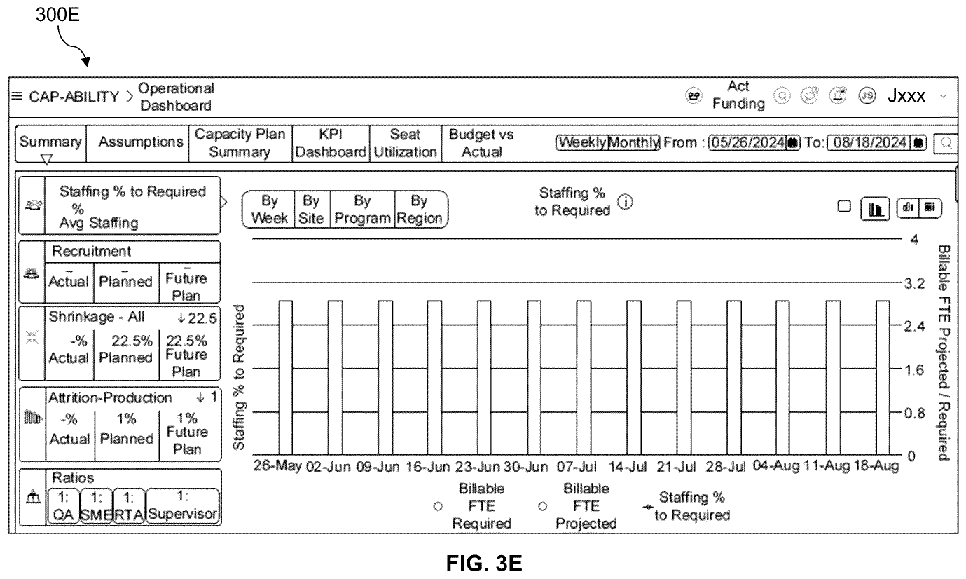

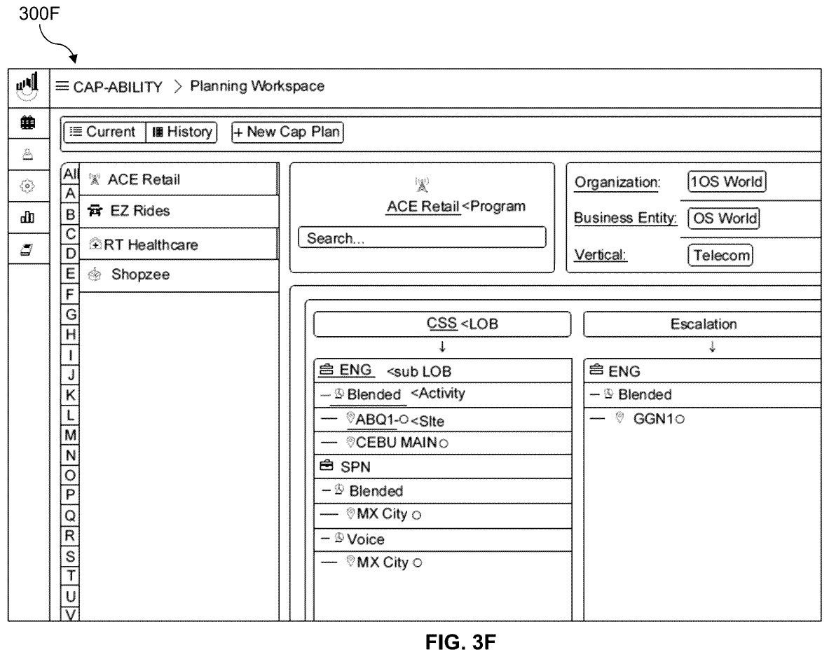

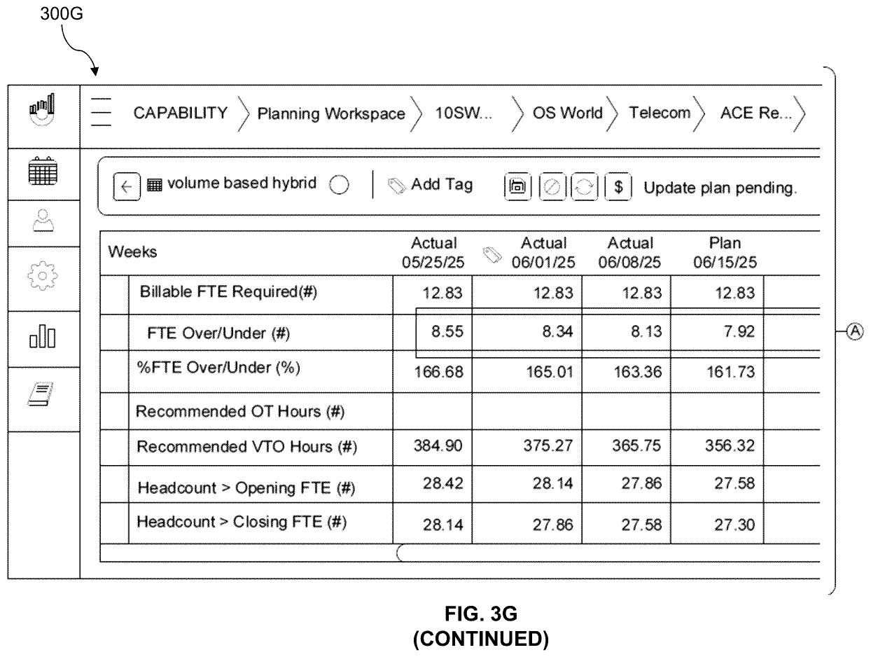

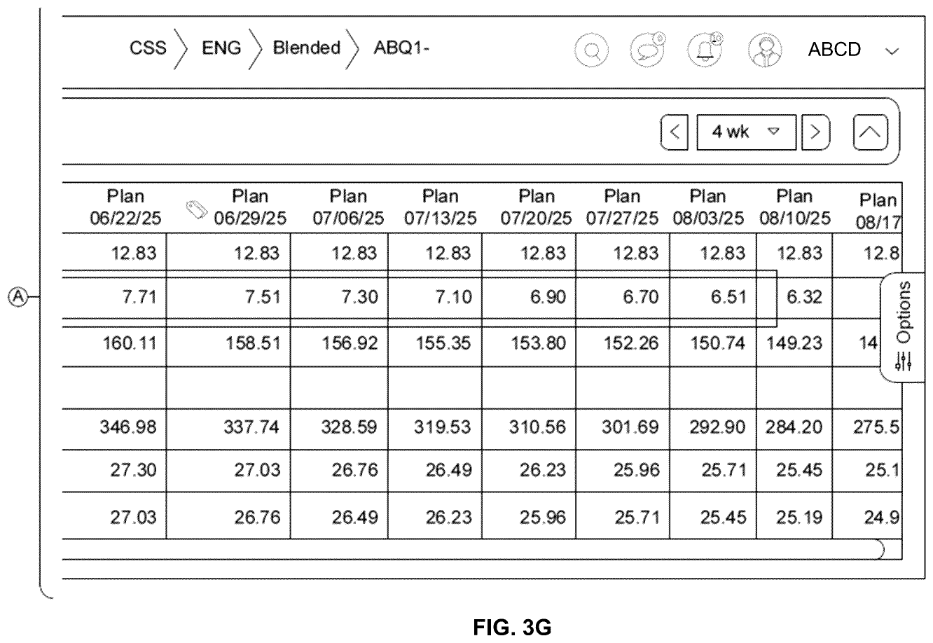

FIG. 3A illustrates an exemplary first visual representation 300A of the one or more user interfaces associated with the one or more communication devices 114 depicting one or more workforce metrics, in accordance with an embodiment of the present disclosure.

In an exemplary embodiment, the one or more user interfaces may display a table with one or more workforce metrics related to workforce planning. The one or more workforce metrics may include, but not constrained to, at least one of: billable full-time equivalent (FTE) required, FTE required with shrinkage, productivity, billable FTE projected, FTE over/under, buffer percentage, budgeted buffer percentage, and the like. In some cases, the user interface may display actual values and planned values for the one or more workforce metrics across various time periods, allowing for comparison and analysis.

The one or more user interface may display one or more options for viewing different aspects of workforce planning. The one or more options may include, but not constrained to, at least one of: headcount, attrition, shrinkage, training lifecycle, ratios, seat utilization, budget vs actual, new employee, the employee roster, notes, the historical data, and the like. This modular approach may allow the one or more users to focus on specific areas of interest within workforce planning process.

The one or more user interfaces may display one or more workforce parameters. The one or more workforce parameters may include interactions received, interactions processed, processing time, service level, occupancy, peak staffing, concurrency, FTE, overtime and Voluntary Time Off (VTO), billable, scheduling index, and custom fields. In some implementations, the computer-implemented system 102 may allow the one or more users to at least one of: input values and view values for the one or more workforce parameters across the various time periods, thereby facilitating detailed analysis and forecasting.

The one or more user interfaces may display date selectors and navigation tools, enabling the one or more users to analyze data for specific time frames. This feature may support historical data analysis and future planning.

In certain aspects, the computer-implemented system 102 may facilitate comprehensive workforce management by providing a centralized platform for data visualization, analysis, and forecasting. The computer-implemented system 102 may allow the one or more users to monitor key performance indicators, adjust the recruitment levels, and make data-driven decisions for employee allocation.

The computer-implemented system 102 may include one or more pre-built industry standard billing module templates for workforce planning. The one or more pre-built industry standard billing module templates may streamline the workforce planning process by providing standardized formats and calculations. In some cases, the one or more pre-built industry standard billing module templates may be customizable to accommodate specific organizational needs while maintaining consistency across different planning scenarios.

By integrating various aspects of workforce management into a single interface, the computer-implemented system 102 may enable more efficient and accurate workforce planning. The computer-implemented system 102 may allow for the creation of the one or more scenarios, which may be compared to provide simulated forward workforce planning methodologies. This capability may enhance the ability of the one or more organizations to adapt to changing business conditions and optimize the employee allocation.

FIG. 3B illustrates an exemplary second visual representation 300B of the one or more user interfaces depicting one or more workforce plans, in accordance with an embodiment of the present disclosure.

In an exemplary embodiment, the one or more user interfaces may display one or more input fields for configuring different types of the one or more workforce plans. In some aspects, the computer-implemented system 102 may allow for the creation and comparison of the one or more scenarios, enabling the one or more organizations to evaluate various workforce management strategies.

The one or more user interfaces may display an input field of the one or more input fields for entering a “plan name” and a dropdown menu for selecting a “plan type”. The “plan type” options may include, but not constrained to, at least one of: volume based, human capital (HC) based, billable hours based, FTE based (BS), volume-based hybrid, volume based with backlog, and the like. This variety of the plan types (workforce plans) may allow the one or more users to tailor the one or more workforce plans to the specific organizational needs and planning methodologies.

In some cases, the one or more user interfaces may display a “start week” input where the one or more users enter a date. The computer-implemented system 102 may include a calendar icon, potentially facilitating easy date selection. The one or more user interfaces may also display a “full-time weekly hours” field, which may be pre-populated with a default value such as “40”. The “full-time weekly hours” field may allow the one or more organizations to adjust a standard work week duration according to the policies.

The one or more user interfaces may display an “Is current plan?” toggle switch, enabling the one or more users to designate whether a workforce plan of the one or more workforce plans being created is an active workforce plan. This feature may assist in managing the one or more scenarios while clearly identifying the current operational plan.

In some implementations, the one or more user interfaces may display a “tag” field with a “search tags . . . ” input box. The computer-implemented system 102 may provide a list of predefined tags, such as, but not constrained to, at least one of: none, annual budget, forecast Q₁, forecast Q₃, forecast Q₂, and the like. The list of predefined tags may facilitate the one or more organizations for quick retrieval of different workforce planning scenarios.

In certain aspects, the computer-implemented system 102 may allow the one or more users to create the one or more workforce plans with different parameters and assumptions. This capability may enable the one or more organizations to develop and compare various scenarios, such as optimistic, pessimistic, and most likely forecasts. By facilitating the creation of the one or more scenarios, the computer-implemented system 102 may support more robust decision-making processes in the workforce management.

The computer-implemented system 102 may provide functionality to compare the one or more workforce planning scenarios, potentially highlighting differences in key metrics and outcomes. This comparison feature may assist the one or more users in identifying the most suitable workforce planning strategy based on various potential future scenarios.

FIG. 3C illustrates an exemplary third visual representation 300C of the one or more user interfaces depicting an addition of new employee acquisition, in accordance with an embodiment of the present disclosure.

In an exemplary embodiment, the one or more user interfaces may display the one or more input fields for entering details about a new employee of the one or more employees and configuring the onboarding process. In some aspects, the computer-implemented system 102 is configured to manage and plan for the new employee, allowing for detailed scheduling and tracking of the onboarding process.

The one or more user interfaces may display the one or more input fields for entering a class reference and source unique Identity (ID). The one or more input fields may allow the one or more organizations to categorize and track the new employee based on specific criteria and recruitment sources. In some cases, the one or more user interfaces may display an input field of the one or more input fields to specify the number of graduates (employees) needed, which may be set to a default value such as 1. The one or more user interfaces may also display a billable headcount field, which may be used to indicate when the new employee is expected to contribute to billable work.

In certain implementations, the one or more user interfaces may also display options to set the class status as one of: tentative and confirmed. This feature may allow the one or more organizations to plan for potential new employee while maintaining flexibility in the workforce planning. The one or more user interfaces may display date fields for various stages of the onboarding process, such as, but not constrained to, at least one of: induction starts on, training starts on, nesting starts on, and production starts on, roster submission by, and the like. The date fields may enable detailed scheduling of the journey of the new employee from initial induction to full productivity.

The one or more user interfaces may allow the one or more users to specify the duration of different onboarding phases. For instance, the one or more user interfaces may display the one or more input fields for specifying the number of training weeks and nesting weeks. In some cases, a field for roster submission timelines may also be displayed, potentially allowing the one or more organizations to coordinate the administrative aspects of bringing on the new employee.

The one or more user interfaces may display a dropdown menu for class type, which may allow the one or more users to categorize the new employee based on one of: the role and the type of training the new employee may receive. This categorization may assist in the employee allocation and scheduling within the computer-implemented system 102.

In some implementations, the one or more user interfaces may display a summary of the recruitment action, such as a “to be hired” indicator showing the number of new employees being added. This feature may provide a quick reference for the one or more users managing multiple hiring actions simultaneously. These controls may provide flexibility in the workforce planning process, enabling the one or more users to refine details before finalizing the new employee entry.

By providing a comprehensive interface for adding new employees, the computer-implemented system 102 may enable the one or more organizations to streamline the onboarding processes and integrate new employee data seamlessly into workforce planning. The detailed scheduling capabilities may allow for more accurate forecasting and the employee allocation, potentially improving overall operational efficiency.

FIG. 3D illustrates an exemplary fourth visual representation 300D of the one or more user interfaces depicting an employee roster, in accordance with an embodiment of the present disclosure.

In an exemplary embodiment, the one or more user interfaces may display the employee roster with various functionalities for managing the employee data and workflows. In some aspects, the computer-implemented system 102 may integrate the employee roster for workforce planning and reconciliation of headcount with actual personnel names.

The one or more user interfaces may display a navigation bar with different tabs, including, but not constrained to, at least one of: forecast & workload, headcount, attrition, shrinkage, training lifecycle, ratios, seat utilization, budget vs actual, new employee, the employee roster, notes, historical data, and the like. In some cases, the one or more user interfaces allows the one or more users to easily switch between different aspects of the workforce management.

The one or more user interfaces may display one or more action buttons for managing employee records. The one or more action buttons may include functionalities such as, but not constrained to, at least one of: adding new employees, processing transfers and promotions, managing leaves of absence, terminating the one or more employees, converting between full-time and part-time status, undoing actions, changing employee classes, extending nesting periods, rehiring former one or more employees, and the like. This comprehensive set of actions may allow for efficient management of the entire employee lifecycle within the computer-implemented system 102.

In some implementations, the main section of the one or more user interfaces may display a table with detailed employee data. The table may include columns for, but not limited to at least one of: employee ID, name, class reference, class type, work status, termination status, role, fixed/flexi hours status, and the like. This structure may allow for easy visualization and management of the workforce. By integrating the employee roster with workforce planning functions, the computer-implemented system 102 may allow for more accurate and detailed workforce management.

FIG. 3E illustrates an exemplary fifth visual representation 300E of the one or more user interfaces depicting an operational dashboard, in accordance with an embodiment of the present disclosure.

In an exemplary embodiment, the operational dashboard may display one or more metrics, and the one or more graphs related to recruitment and the employee allocation. The dashboard may feature a graph of the one or more graphs that may show recruitment (staffing) percentages over time, potentially using a bar graph to represent “billable FTE required” and “billable FTE projected.”

The dashboard may display the one or more metrics that may include, but not constrained to, at least one of: staffing % to required, recruitment, shrinkage, attrition, ratios, and the like. In some implementations, the one or more metrices may provide at-a-glance information on critical workforce management factors.

The dashboard may serve as a central platform for monitoring and analyzing the one or more metrics, enabling the one or more organizations to manage the workforce more effectively. The one or more graphs may allow the one or more users to quickly assess the alignment of current recruitment levels with the required levels, facilitating timely adjustments to workforce planning.

FIG. 3F illustrates an exemplary sixth visual representation 300F of the one or more user interfaces depicting a hierarchy structure of the one or more organizations for each capacity plan, in accordance with an embodiment of the present disclosure.

The one or more user interfaces may display the hierarchy structure of the one or more organizations such as organization (e.g., 1OS World)—Business Entity (e.g., OS World)—Vertical (e.g., Telecom)—Program (e.g., ACE Retail)−line of business (LOB)—Sub LOB—Activity-Site, for each capacity plan. The one or more user interfaces may display the capacity plans that are created at each site level. The detailed description of the determined/projected number of workforces (full-time equivalent (FTE) counts) are explained in FIG. 2.

FIG. 3G illustrates an exemplary seventh visual representation 300G of the one or more user interfaces depicting staffing capacity plans (over/under workforces), in accordance with an embodiment of the present disclosure.

The one or more user interfaces may display the staffing capacity plans (i.e., over/under staffing) for every week, based on the comparison of obtained one or more requirements of workforce allocation with the determined number of projected workforces. Based on this information, the computer-implemented system 102 is configured to recommend whether the additional hiring is required for workloads or do the current workforces want to run overtime to manage staffing gaps.

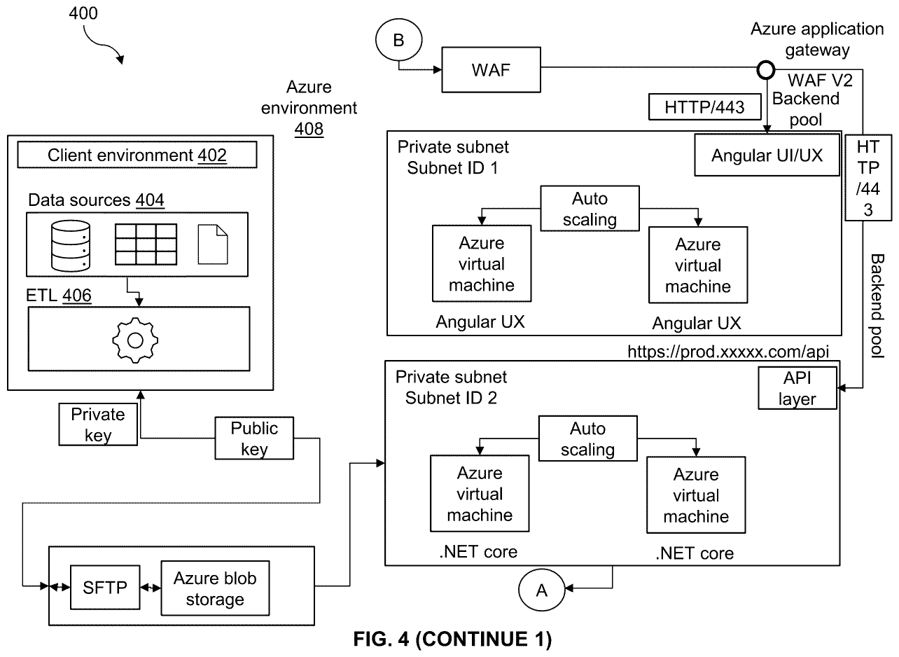

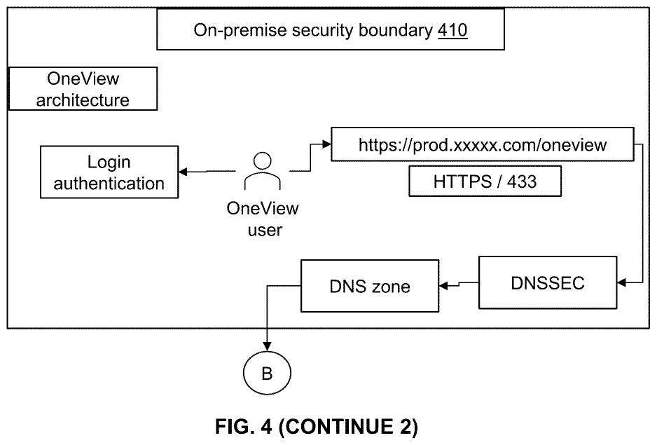

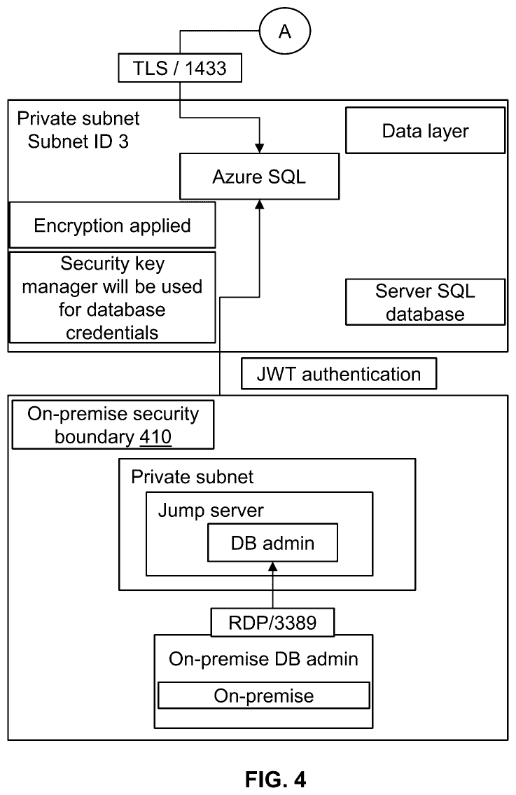

FIG. 4 illustrates an exemplary system architecture 400 for dynamic workforce planning, in accordance with an embodiment of the present disclosure.

In an exemplary embodiment, the system architecture 400 integrating on-premise and cloud components is illustrated in FIG. 4. In some aspects, the computer-implemented system 102 may utilize a hybrid architecture that combines on-premise infrastructure with cloud-based services to provide a comprehensive and secure solution for workforce management and planning.

The system architecture 400 may include three main sections: a client environment 402, an Azure environment 408, and an on-premise security boundary 410. In some cases, the client environment 402 may comprise one or more data sources 404. The one or more data sources 404 may include the one or more databases 116, spreadsheets, and comma-separated values (CSV) files. The one or more data sources 404 may be connected to an Extract, Transform, Load (ETL) 406 process, which may prepare the data for use in the computer-implemented system 102.

The Azure environment 408 may form a core of the computer-implemented system 102, leveraging one or more Azure services to provide scalable and secure processing capabilities. In some implementations, the Azure environment 408 may include an Azure Application Gateway with Web Application Firewall (WAF) functionality. The Azure Application Gateway with the WAF functionality may serve as a front-end security layer, protecting the system 102 from common web vulnerabilities and attacks.

The Azure environment 408 may be divided into a plurality of subnets, each serving a specific purpose within the computer-implemented system 102. In some cases, a first subnet of the plurality of subnets labeled Angular user interface (UI)/user experience (UX) may configured with one or more Azure Virtual Machines running Angular-based user interface applications. A second subnet of the plurality of subnets labeled as Application Programming Interface (API) layer may house the one or more Azure Virtual Machines running .NET core applications, which may handle backend processing and business logic.

A third subnet of the plurality of subnets is data layer within the Azure environment 408 may include one or more Azure Structured Query Language (SQL) databases. The one or more Azure SQL databases may store and manage the data used by the computer-implemented system 102, potentially including the historical workforce data, planning parameters, and the generated one or more forecasts.

In some aspects, the computer-implemented system 102 may implement additional security measures within the Azure environment 408. The additional security measures may include a private subnet for Jump Server access, which may provide secure remote access to the computer-implemented system's 102 resources. The computer-implemented system 102 may also utilize an Azure Key Vault for secure key management, thereby assisting in protecting sensitive information and credentials used within the workforce planning solution.

The on-premise security boundary 410 section of the system architecture 400 may show user authentication and Domain Name System (DNS) components. In some implementations, the on-premise security boundary 410 section may include a login authentication module, which may connect to one of: an on-premise user directory and an identity provider. The on-premise security boundary 410 may also feature a Domain Name System Security Extensions (DNSSEC) component and a DNS Zone, which are configured to ensure secure and reliable domain name resolution for the computer-implemented system 102.

In some cases, Hypertext Transfer Protocol (HTTP)/Hypertext Transfer Protocol Secure (HTTPS) protocols may be indicated for various connections throughout the computer-implemented system 102, ensuring secure communication between different parts of the system architecture 400.

By integrating on-premise systems with one or more cloud-based Azure services, the computer-implemented system 102 may provide a comprehensive solution that balances security, scalability, and performance. The hybrid architecture may allow the one or more organizations to leverage existing on-premise infrastructure while taking advantage of the advanced capabilities and flexibility provided by the one or more cloud-based Azure services.

In some implementations, the computer-implemented system 102 may utilize Azure's built-in security features and compliance certifications to meet regulatory requirements and protect sensitive workforce data. The employment of the one or more cloud-based Azure services may also enable the computer-implemented system 102 to scale resources dynamically based on demand, potentially improving performance during peak usage periods.

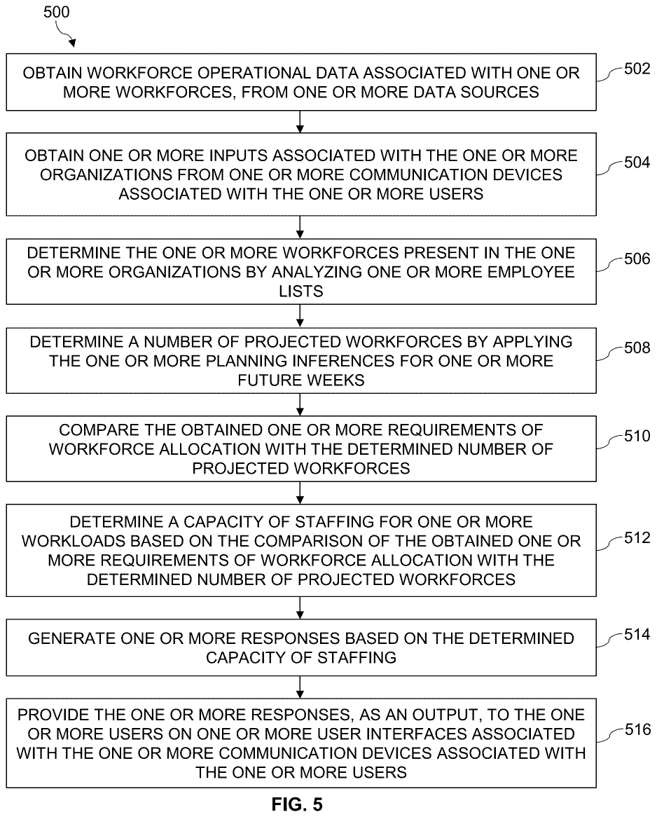

FIG. 5 illustrates a flow chart illustrating a computer-implemented method 500 for automatically managing the dynamic workforces in the one or more organizations, in accordance with an embodiment of the present disclosure.

At step 502, the workforce operational data associated with the one or more workforces, are obtained from the one or more data sourcing systems.

At step 504, the one or more inputs associated with the one or more organizations are obtained from the one or more communication devices 114 associated with the one or more users. In an embodiment, the one or more inputs may include at least one of: the one or more requirements of allocation of workforces for future business needs, the one or more requirements of the future business needs, and the one or more planning inferences comprising at least one of: the one or more projected attrition inferences, the one or more projected shrinkage inferences, and the one or more projected hiring inferences, on the one or more workforces.

At step 506, the one or more workforces present in the one or more organizations are determined by analyzing one or more employee lists.

At step 508, the number of projected workforces is determined by applying the one or more planning inferences for the one or more future weeks.

At step 510, the obtained one or more requirements of workforce allocation are compared with the determined number of projected workforces.

At step 512, the capacity of staffing for the one or more workloads is determined based on the comparison of the obtained one or more requirements of workforce allocation with the determined number of projected workforces.

At step 514, the one or more responses are generated based on the determined capacity of staffing. In an embodiment, the one or more responses may include at least one of: the requirement of recruitment of the one or more workforces in future and managing the staffing gaps by utilizing the one or more workforces present in the one or more organizations to work overtime.

At step 516, the one or more responses are provided, as the output, to the one or more users on the one or more user interfaces associated with the one or more communication devices 114 associated with the one or more users.

Numerous advantages of the present disclosure may be apparent from the discussion above. In accordance with the present disclosure, the computer-implemented system 102 for managing dynamic workforce planning, is disclosed. The computer-implemented system 102 is configured to assist the one or more organizations in determining the workforce requirements through streamlined processes. By integrating automated workflows for employee lifecycle management, the computer-implemented system 102 efficiently manages data capture related to one or more workload operational data, simplifying the traditionally cumbersome manual data entry.

The one or more users may easily build and modify the one or more scenarios to account for ever-changing business dynamics, ensuring the computer-implemented system 102 remains flexible and responsive. Additionally, the computer-implemented system 102 is configured to create the one or more reports and one or more dashboards, providing the one or more users with a user-friendly interface to visualize and manage information related to the workforce effectively. A planning roll-up feature allows the one or more organizations to assess the requirements of the one or more employees at different levels, such as project level, client level, vertical level, location level, and organization level, ensuring alignment between high-level strategic objectives and day-to-day operational requirements.

The computer-implemented system 102 is configured to utilize business model-based plan creation, allowing for the generation of accurate, tailored one or more workforce plans based on industry-specific models. The computer-implemented system 102 is configured to leverage standardized formats and calculations, ensuring consistency and reducing errors across workforce planning activities. By integrating the employee roster, the computer-implemented system 102 is configured to provide a holistic view of workforce availability. The computer-implemented system 102 is configured to support automated on-demand reporting, making performance tracking more efficient.

Additionally, the computer-implemented system 102 is configured to manage training classes and project revenue and the expenses related to recruitment decisions, thereby providing a comprehensive view of the financial impact. Version comparison capabilities allow for easy tracking of changes over time, while trends-based automated planning assumptions forecast future recruitment requirements. The computer-implemented system 102 is configured to ensure an error-proof planning model, thereby enhancing overall accuracy and reliability in workforce management and planning.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the computer-implemented system 102 either directly or through intervening I/O controllers. Network adapters may also be coupled to the computer-implemented system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer-implemented system 102 in accordance with the embodiments herein. The computer-implemented system 102 herein comprises at least one processor or central processing unit (CPU). The CPUs are interconnected via the system bus 202 to various devices such as a random-access memory (RAM), read-only memory (ROM), and an input/output (I/O) adapter. The I/O adapter can connect to peripheral devices, such as disk units and tape drives, or other program storage devices that are readable by the computer-implemented system 102. The computer-implemented system 102 can read the inventive instructions on the program storage devices and follow these instructions to execute the methodology of the embodiments herein.

The computer-implemented system 102 further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A computer-implemented method for automatically managing dynamic workforces in one or more organizations, the computer-implemented method comprising:
obtaining, by one or more hardware processors, workforce operational data associated with one or more workforces, from one or more data sourcing systems;
obtaining, by the one or more hardware processors, one or more inputs associated with the one or more organizations from one or more communication devices associated with the one or more users,
wherein the one or more inputs comprise at least one of: one or more requirements of allocation of workforces for future business needs, one or more requirements of the future business needs, and one or more planning inferences comprising at least one of:
one or more projected attrition inferences, one or more projected shrinkage inferences, and one or more projected hiring inferences, on the one or more workforces;
determining, by the one or more hardware processors, the one or more workforces present in the one or more organizations by analyzing one or more employee lists;
determining, by the one or more hardware processors, a number of projected workforces by applying the one or more planning inferences for one or more future weeks;
comparing, by the one or more hardware processors, the obtained one or more requirements of workforce allocation with the determined number of projected workforces;
determining, by the one or more hardware processors, a capacity of staffing for one or more workloads based on the comparison of the obtained one or more requirements of workforce allocation with the determined number of projected workforces;
generating, by the one or more hardware processors, one or more responses based on the determined capacity of staffing, wherein the one or more responses comprise at least one of: requirement of recruitment of the one or more workforces in future and managing staffing gaps by utilizing the one or more workforces present in the one or more organizations to work overtime; and
providing, by the one or more hardware processors, the one or more responses, as an output, to the one or more users on one or more user interfaces associated with the one or more communication devices associated with the one or more users.

2. The computer-implemented method of claim 1, wherein generating the one or more responses comprises:
obtaining, by the one or more hardware processors, the one or more inputs from the one or more communication devices associated with the one or more users, wherein the one or more inputs comprise one or more queries associated with one or more scenarios, and wherein the one or more scenarios comprise at least one of: recruitment of one or more workforces based on changes in demand of the one or more workforces in a time duration, and the recruitment of the one or more workforces based on the changes in the recruitment at a specific location; and
generating, by the one or more hardware processors, the one or more responses based on the one or more queries using at least one of: historical data, one or more trends, and one or more business model inferences.

3. The computer-implemented method of claim 2, wherein:
the historical data comprise at least one of: one or more recruitment records, historical workforce data, and performance and productivity data,
the one or more trends comprise at least one of: relationship between the demand and the recruitment, seasonal recruitment patterns, availability of one or more regional workforces, recruitment lead time, attrition and retention rates, and cost trends, and
the one or more business model inferences comprise at least one of: recruitment-to-demand elasticity, location-based hiring constraints, operational capacity limits, recruitment cost and time inferences, workforce productivity metrics, attention and retention forecasting, and revenue per workforce.

4. The computer-implemented method of claim 1, further comprising:
obtaining, by the one or more hardware processors, information associated with the recruitment of each workforce of the one or more workforces;
analyzing, by the one or more hardware processors, one or more factors comprising at least one of: wages, overtime pay, potential recruitment expenses, training expenses, associated with each workforce of the one or more workforces;
generating, by the one or more hardware processors, the one or more responses associated with one or more expense information for each workforce of the one or more workforces; and
generating, by the one or more hardware processors, one or more recommendations on a budgetary impact of at least one of: maintaining the one or more workforces, increasing the one or more workforces, and decreasing the one or more workforces, by analyzing the one or more expense information associated with each workforce of the one or more workforces.

5. The computer-implemented method of claim 1, further comprising:
analyzing, by the one or more hardware processors, one or more workforce based factors comprising at least one of: the one or more workloads, one or more business goals, one or more seasonal trends, and one or more operational trends; and
generating, by the one or more hardware processors, the one or more responses associated with allocation of the one or more workforces to be required to meet the demand in each scenario of the one or more scenarios.

6. The computer-implemented method of claim 1, further comprising generating, by the one or more hardware processors, one or more reports based on at least one of: the one or more requirements of the allocation of workforces for the future business needs, the one or more responses, the one or more scenarios,
wherein the one or more reports comprise at least one of: determined workforces for each scenario, financial cost projections, one or more graphs showing how needs change over time, and one or more recommendations for recruitment adjustments.

7. The computer-implemented method of claim 1, further comprising generating, by the one or more hardware processors, the one or more projected attrition inferences using a machine learning (ML) model, by:
collecting, by the one or more hardware processors, one or more training datasets comprising one or more first historical workforce datasets, wherein the one or more first historical workforce datasets comprise at least one of: one or more past attrition records, one or more employee attributes, and work location and team dynamics;
generating, by the one or more hardware processors, one or more first features comprising at least one of: tenure duration, attrition seasonality, risk scores, and attrition trends by department, based on the one or more training datasets;
training, by the one or more hardware processors, the ML model to learn one or more patterns of past attritions comprising at least one of: who is leaving from the one or more organizations and under what conditions, how organizational and external events impact turnover, and trends in voluntary versus involuntary exits; and
generating, by the one or more hardware processors, the one or more projected attrition inferences using the trained ML model.

8. The computer-implemented method of claim 1, further comprising generating, by the one or more hardware processors, the one or more projected shrinkage inferences using the machine learning (ML) model, by:
collecting, by the one or more hardware processors, the one or more training datasets comprising one or more second historical workforce datasets, wherein the one or more second historical workforce datasets comprise at least one of: one or more employee attrition records, past recruitment cycles and hiring rates, one or more resignation trends by role, department, and location, one or more cyclical shrinkage patterns, and internal mobility;
generating, by the one or more hardware processors, one or more second features comprising at least one of: time-based variables, employee attributes, location-based factors, demand fluctuations, and performance metrics, based on the one or more training datasets;
training, by the one or more hardware processors, the ML model to learn at least one of: one or more patterns of past workforce shrinkage, correlations between events and staff reductions, and recurring trends over specific periods and business cycles; and
generating, by the one or more hardware processors, the one or more projected shrinkage inferences based on the trained ML model.

9. The computer-implemented method of claim 1, wherein:
the one or more data sourcing systems comprise at least one of: one or more human resource information systems (HRIS), one or more scheduling tools, and one or more financial reporting systems, and
the workforce operational data comprise at least one of: an employee roster, work hours, one or more historical performance metrics, one or more business targets, and metadata associated with the one or more workforces.

10. A computer-implemented system for automatically managing dynamic workforces in one or more organizations, the computer-implemented system comprising:
one or more hardware processors;
a memory unit coupled to the one or more hardware processors, wherein the memory unit comprises a plurality of subsystems in form of programmable instructions executable by the one or more hardware processors, and wherein the plurality of subsystems comprises:
a data obtaining subsystem configured to:
obtain workforce operational data associated with one or more workforces, from one or more data sourcing systems; and
obtain one or more inputs associated with the one or more organizations from one or more communication devices associated with the one or more users,
wherein the one or more inputs comprise at least one of: one or more requirements of allocation of workforces for future business needs, one or more requirements of the future business needs, and one or more planning inferences comprising at least one of: one or more projected attrition inferences, one or more projected shrinkage inferences, and one or more projected hiring inferences, on the one or more workforces;
a workforce determining subsystem configured to:
determine the one or more workforces present in the one or more organizations by analyzing one or more employee lists; and
determine a number of projected workforces by applying the one or more planning inferences for one or more future weeks;
a staffing capacity determining subsystem configured to:
compare the obtained one or more requirements of workforce allocation with the determined number of projected workforces; and
determine a capacity of staffing for one or more workloads based on the comparison of the obtained one or more requirements of workforce allocation with the determined number of projected workforces;
a response generating subsystem configured to generate one or more responses based on the determined capacity of staffing, wherein the one or more responses comprise at least one of: requirement of recruitment of the one or more workforces in future and managing staffing gaps by utilizing the one or more workforces present in the one or more organizations to work overtime; and
an output subsystem configured to provide the one or more responses, as an output, to the one or more users on one or more user interfaces associated with the one or more communication devices associated with the one or more users.

11. The computer-implemented system of claim 10, wherein in generating the one or more responses, the response generating subsystem is configured to:
obtain the one or more inputs from the one or more communication devices associated with the one or more users, wherein the one or more inputs comprise one or more queries associated with one or more scenarios, and wherein the one or more scenarios comprise at least one of: recruitment of one or more workforces based on changes in demand of the one or more workforces in a time duration, and the recruitment of the one or more workforces based on the changes in the recruitment at a specific location; and
generate the one or more responses based on the one or more queries using at least one of: historical data, one or more trends, and one or more business model inferences.

12. The computer-implemented system of claim 11, wherein:
the historical data comprise at least one of: one or more recruitment records, historical workforce data, and performance and productivity data,
the one or more trends comprise at least one of: relationship between the demand and the recruitment, seasonal recruitment patterns, availability of one or more regional workforces, recruitment lead time, attrition and retention rates, and cost trends, and
the one or more business model inferences comprise at least one of: recruitment-to-demand elasticity, location-based hiring constraints, operational capacity limits, recruitment cost and time inferences, workforce productivity metrics, attention and retention forecasting, and revenue per workforce.

13. The computer-implemented system of claim 10, further comprising an expense estimation module in the response generating subsystem configured to:
obtain information associated with the recruitment of each workforce of the one or more workforces;
analyze one or more factors comprising at least one of: wages, overtime pay, potential recruitment expenses, training expenses, associated with each workforce of the one or more workforces;
generate the one or more responses associated with one or more expense information for each workforce of the one or more workforces; and
generate one or more recommendations on a budgetary impact of at least one of: maintaining the one or more workforces, increasing the one or more workforces, and decreasing the one or more workforces, by analyzing the one or more expense information associated with each workforce of the one or more workforces.

14. The computer-implemented system of claim 10, further comprising an employee estimation module in the response generating subsystem configured to:
analyze one or more workforce based factors comprising at least one of: the one or more workloads, one or more business goals, one or more seasonal trends, and one or more operational trends; and
generate the one or more responses associated with allocation of the one or more workforces to be required to meet the demand in each scenario of the one or more scenarios.

15. The computer-implemented system of claim 10, further comprising a report generating subsystem configured to generate one or more reports based on at least one of: the one or more requirements of the allocation of workforces for the future business needs, the one or more responses, the one or more scenarios,
wherein the one or more reports comprise at least one of: determined workforces for each scenario, financial cost projections, one or more graphs showing how needs change over time, and one or more recommendations for recruitment adjustments.

16. The computer-implemented system of claim 10, further comprising an inference generating subsystem configured to generate the one or more projected attrition inferences using a machine learning (ML) model, by:
collecting one or more training datasets comprising one or more first historical workforce datasets, wherein the one or more first historical workforce datasets comprise at least one of: one or more past attrition records, one or more employee attributes, and work location and team dynamics;
generating one or more first features comprising at least one of: tenure duration, attrition seasonality, risk scores, and attrition trends by department, based on the one or more training datasets;
training the ML model to learn one or more patterns of past attritions comprising at least one of: who is leaving from the one or more organizations and under what conditions, how organizational and external events impact turnover, and trends in voluntary versus involuntary exits; and
generating the one or more projected attrition inferences using the trained ML model.

17. The computer-implemented system of claim 10, wherein the inference generating subsystem is further configured to generate the one or more projected shrinkage inferences using the machine learning (ML) model, by:
collecting the one or more training datasets comprising one or more second historical workforce datasets, wherein the one or more second historical workforce datasets comprise at least one of: one or more employee attrition records, past recruitment cycles and hiring rates, one or more resignation trends by role, department, and location, one or more cyclical shrinkage patterns, and internal mobility;
generating one or more second features comprising at least one of: time-based variables, employee attributes, location-based factors, demand fluctuations, and performance metrics, based on the one or more training datasets;
training the ML model to learn at least one of: one or more patterns of past workforce shrinkage, correlations between events and staff reductions, and recurring trends over specific periods and business cycles; and
generating the one or more projected shrinkage inferences based on the trained ML model.

18. The computer-implemented system of claim 10, wherein:
the one or more data sources comprise at least one of: one or more human resource information systems (HRIS), one or more scheduling tools, and one or more financial reporting systems, and
the workforce operational data comprise at least one of: an employee roster, work hours, one or more historical performance metrics, one or more business targets, and metadata associated with the one or more workforces.

19. A non-transitory computer-readable storage medium having instructions stored therein that when executed by one or more hardware processors, cause the one or more hardware processors to execute operations of:
obtaining workforce operational data associated with one or more workforces, from one or more data sourcing systems;
obtaining one or more inputs associated with the one or more organizations from one or more communication devices associated with the one or more users, wherein the one or more inputs comprise at least one of: one or more requirements of allocation of workforces for future business needs, one or more requirements of the future business needs, and one or more planning inferences comprising at least one of: one or more projected attrition inferences, one or more projected shrinkage inferences, and one or more projected hiring inferences, on the one or more workforces;
determining the one or more workforces present in the one or more organizations by analyzing one or more employee lists;
determining a number of projected workforces by applying the one or more planning inferences for one or more future weeks;
comparing the obtained one or more requirements of workforce allocation with the determined number of projected workforces;
determining a capacity of staffing for one or more workloads based on the comparison of the obtained one or more requirements of workforce allocation with the determined number of projected workforces;
generating one or more responses based on the determined capacity of staffing, wherein the one or more responses comprise at least one of: requirement of recruitment of the one or more workforces in future and managing staffing gaps by utilizing the one or more workforces present in the one or more organizations to work overtime; and
providing the one or more responses, as an output, to the one or more users on one or more user interfaces associated with the one or more communication devices associated with the one or more users.

20. The non-transitory computer-readable storage medium of claim 19, wherein generating the one or more responses comprises:
obtaining the one or more inputs from the one or more communication devices associated with the one or more users, wherein the one or more inputs comprise one or more queries associated with one or more scenarios, and wherein the one or more scenarios comprise at least one of: recruitment of one or more workforces based on changes in demand of the one or more workforces in a time duration, and the recruitment of the one or more workforces based on the changes in the recruitment at a specific location; and
generating the one or more responses based on the one or more queries using at least one of: historical data, one or more trends, and one or more business model inferences.
